(19) United States
(12) Patent Application Publication
(10) Pub. No.: US 2007/0147516 A1
(43) Pub. Date: Jun. 28, 2007

(54) Decoding apparatus

(75) Inventor: Tetsuo Kosuge, Gunma-ken (JP)

Correspondence Address: OSHA LIANG L.L.P., 1221 MCKINNEY STREET, SUITE 2800, HOUSTON, TX, 77010, US

(73) Assignee: Sanyo Electric Co., Ltd., Osaka (JP)

(21) Appl. No.: 11/645,819

(22) Filed: Dec. 26, 2006

(30) Foreign Application Priority Data
Dec. 26, 2005 (JP) 2005-373209

(51) Int. Cl. H04N 11/02; H04B 1/66

(52) U.S. Cl. 375/240.25; 375/240.29

(57) ABSTRACT

A frame memory successively stores post-filter data in such a manner that 1-column/1-row pre-filter data extending along the right and lower sides of each block are not overwritten by the post-filter data. Thus, the frame memory stores both the post-filter data used for inter-prediction and the pre-filter data remaining for intra-prediction of a next block. The inter-prediction and the intra-prediction can be simultaneously executed based on the data stored in the frame memory.

### CROSS-REFERENCE TO RELATED APPLICATIONS

The entire disclosure of Japanese Patent Application No. 2005-373209 including the specification, claims, drawings and abstract is incorporated herein by reference.

### BACKGROUND OF THE INVENTION

1. Field of the Invention

The present invention relates to a decoding apparatus that obtains encoded image data and executes decoding processing on the input image data.

2. Description of the Related Art

The H.264 video compression standard can achieve very high data compression in a video encoding/decoding system. Similar to other standards known as MPEG2 and MPEG4, H.264 is based on an encoding technique using motion compensation or inverse conversion or spatial region ←→ frequency region conversion/quantization processing. An H.264 compatible system executes decoding processing for each block with a deblocking filter that can remove block distortion from decoded data.

An H.264 decoding system uses pre-filter data for intra-prediction (prediction based on data in a frame) and uses post-filter data for inter-prediction (prediction based on data of plural frames).

If a frame memory is “temporarily” used for intra-prediction, because the filter processing cannot be started until the intra-prediction is completed, the filter processing is postponed. To deal with this problem, a decoder may include a decoded image memory storing intra-prediction data in addition to a frame memory, so that the filter processing can be executed without any delay.

FIG. 6 illustrates a decoding apparatus. An entropy decoding section 10 inputs a bit stream of encoded data and produces an entropy decoded signal. An inverse quantization/inverse conversion section 12 applies inverse quantization and inverse conversion to the entropy decoded signal. An adder 14 receives an output of the inverse quantization/inverse conversion section 12. The adder 14 also receives inter-prediction data or intra-prediction data. Thus, the adder 14 can produce decoded image data reflecting inter-prediction or intra-prediction.

A decoded image memory storing apparatus 16 receives the decoded image data from the adder 14 and causes a decoded image memory 18 to store the decoded image data. A filter 20 receives the decoded image data from the decoded image memory 18 and applies filter processing to the decoded image data. A frame memory storing apparatus 22 receives filter processed data (hereinafter, referred to as “Post-filter data”) from the filter 20. The frame memory storing apparatus 22 causes a frame memory 24 to store the post-filter data.

A decoded image memory reading apparatus 26 can read non-filtered data (hereinafter, referred to as “pre-filter data”) from the decoded image memory 18. An intra-prediction section 28 receives the pre-filter data from the decoded image memory reading apparatus 26. The intra-prediction section 28 produces an intra-prediction signal based on the pre-filter data.

A frame memory reading apparatus 30 can read post-filter data of plural frames from the frame memory 24. An inter-prediction section 32 receives the post-filter data of plural frames from the frame memory reading apparatus 30. The inter-prediction section 32 produces an inter-prediction signal based on the post-filter data of plural frames.

A selection switch 34 receives the intra-prediction signal from the intra-prediction section 28 and the inter-prediction signal from the inter-prediction section 32. The selection switch 34 can selectively supply the intra-prediction signal or the inter-prediction signal to the adder 14, so that the adder 14 can produce decoded image data based on the inter-prediction signal or the intra-prediction signal.

The decoding apparatus of FIG. 6 performs the decoding processing as described for each block including an appropriate number (e.g., 4×4) of pixels. The filter 20 or the frame memory 24 can output filtered image data at appropriate timing.

For example, an example of the H.264 decoding apparatus is described by Yi Hu et al. in “Development of HDTV compatible H.264 video decoder IP core” (Design Wave Magazine, pp. 105-111, August 2004).

The above-described decoding technique can simultaneously and smoothly execute both the filter processing and the intra-prediction. However, a decoding apparatus based on this technique must include a large-scale memory for storing one frame of decoded image data. Furthermore, the decoding apparatus requires a circuit for reading decoded image data from the memory and a circuit for storing decoded image data into the memory. Thus, the circuit scale of the decoding apparatus grows disadvantageously larger.

### SUMMARY OF THE INVENTION

The present invention can constantly store, in a frame memory, pre-filter data required for intra-prediction. The present invention can realize effective data storage without requiring a frame memory storing pre-filter data used for intra-prediction.

### BRIEF DESCRIPTION OF THE DRAWINGS

The accompanying drawings, which are incorporated in and constitute a part of the specification, illustrate an embodiment of the invention and, together with the description, serve to explain the principles of the invention, in which:

FIG. 1 is a block diagram illustrating a decoding apparatus according to an embodiment of the present invention;

FIGS. 2A and 2B are an illustration of a data storage method;

FIG. 3 is an illustration of image data stored in a frame memory;

FIG. 4 is an illustration of intra-prediction;

FIG. 5 is a block diagram illustrating another decoding apparatus according to an embodiment of the present invention; and

FIG. 6 is a block diagram illustrating a conventional decoding apparatus.

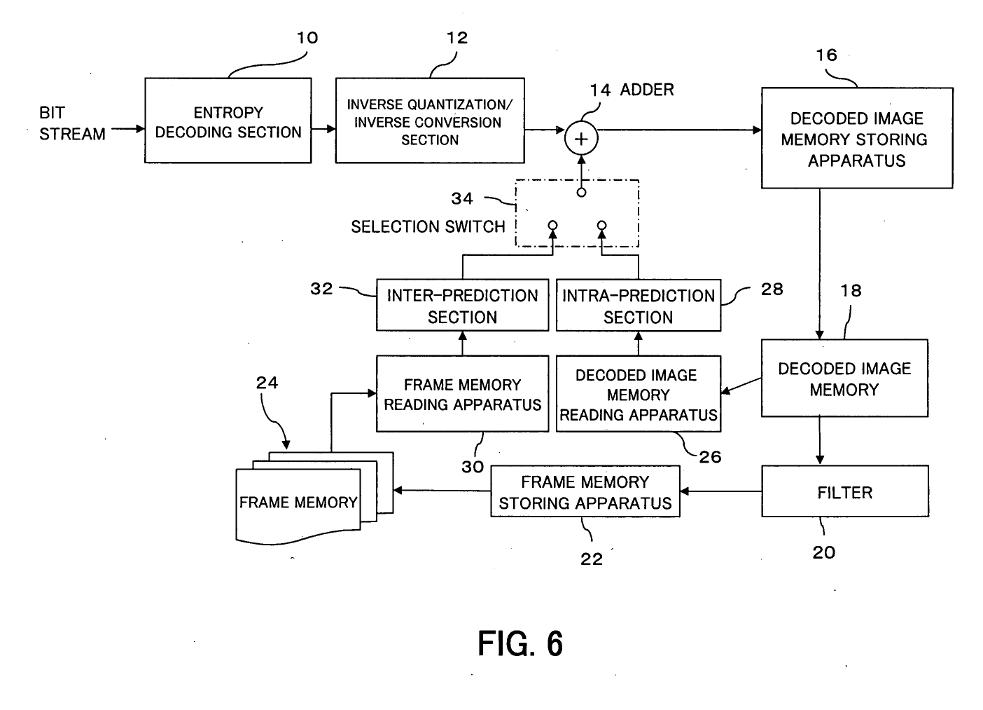

### DESCRIPTION OF PREFERRED EMBODIMENTS

Embodiments of the present invention will be described with reference to the drawings.

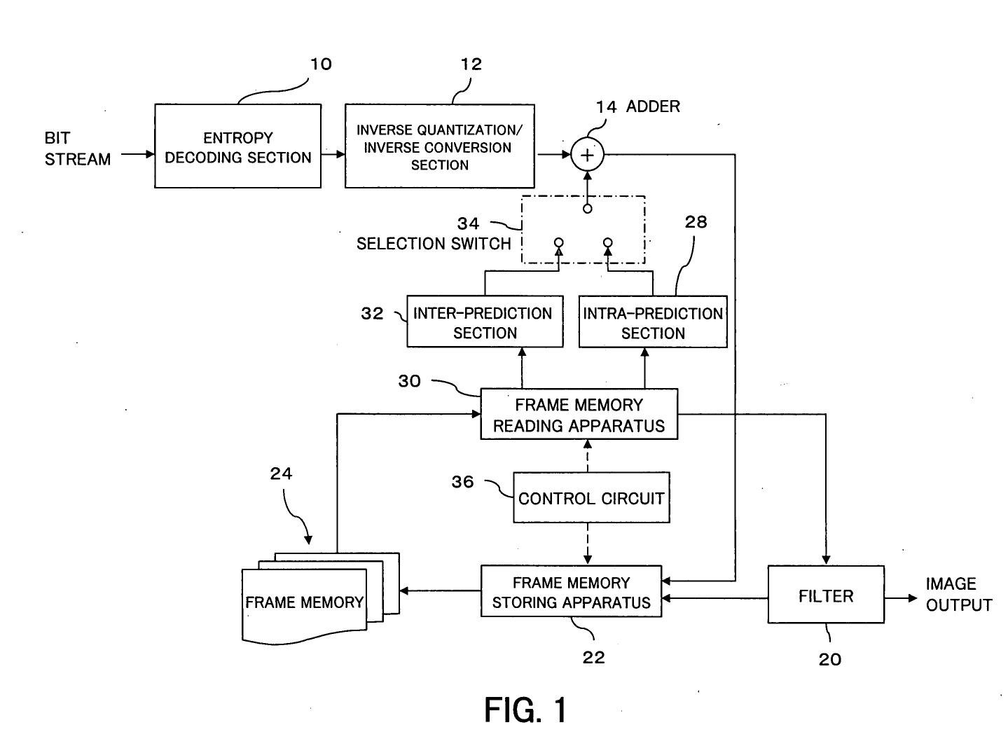

FIG. 1 illustrates a decoding apparatus according to an embodiment of the present invention.

An entropy decoding section 10 inputs a bit stream of encoded data and produces an entropy decoded signal. An inverse quantization/inverse conversion section 12 applies inverse quantization and inverse conversion to the entropy decoded signal. An adder 14 receives an output of the inverse quantization/inverse conversion section 12. The adder 14 also receives inter-prediction data or intra-prediction data. Thus, the adder 14 can produce decoded image data reflecting inter-prediction or intra-prediction.

A frame memory storing apparatus 22 receives the decoded image data (i.e., pre-filter data) from the adder 14. The frame memory storing apparatus 22 writes the pre-filter data into a frame memory 24. A frame memory reading apparatus 30 can read the pre-filter data from the frame memory 24. A filter 20 receives the pre-filter data read from the frame memory reading apparatus 30. The filter 20 applies deblocking filter processing to the pre-filter data. The frame memory storing apparatus 22 writes the filtered data (i.e., post-filter data) into the frame memory 24.

The frame memory reading apparatus 30 supplies predetermined post-filter data of plural frames to an inter-prediction section 32. The inter-prediction section 32 produces an inter-prediction signal based on the received post-filter data. Furthermore, the frame memory reading apparatus 30 reads predetermined pre-filter data from the frame memory 24 and supplies the read pre-filter data to an intra-prediction section 28. The intra-prediction section 28 produces an intra-prediction signal based on the received pre-filter data.

A selection switch 34 receives the intra-prediction signal from the intra-prediction section 28 and the inter-prediction signal from the inter-prediction section 32. The selection switch 34 can selectively supply the intra-prediction signal or the inter-prediction signal to the adder 14, so that the adder 14 can produce decoded image data based on the inter-prediction signal or the intra-prediction signal. A control circuit 36 can control the actions of the frame memory storing apparatus 22, the frame memory reading apparatus 30, and the selection switch 34.

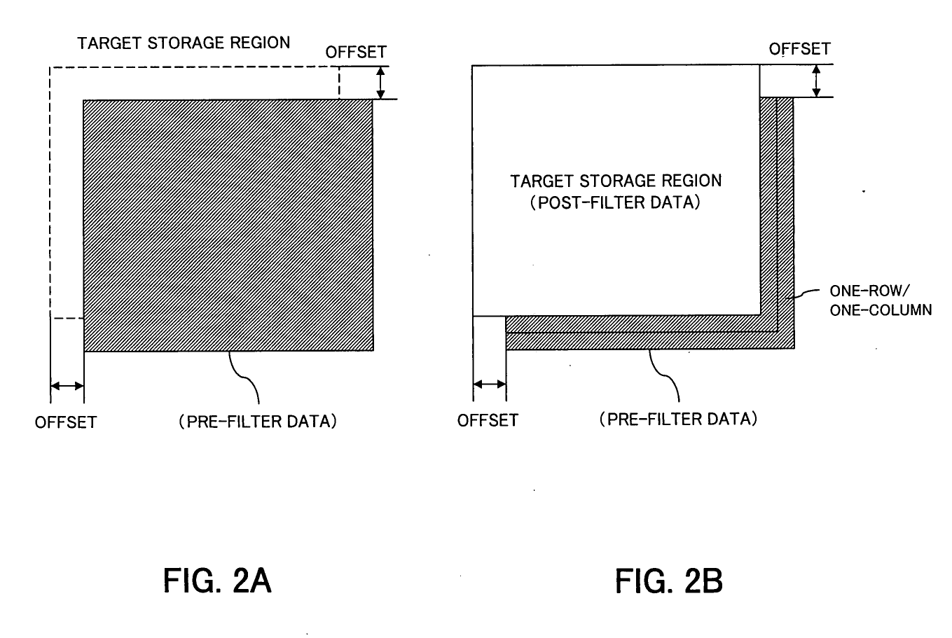

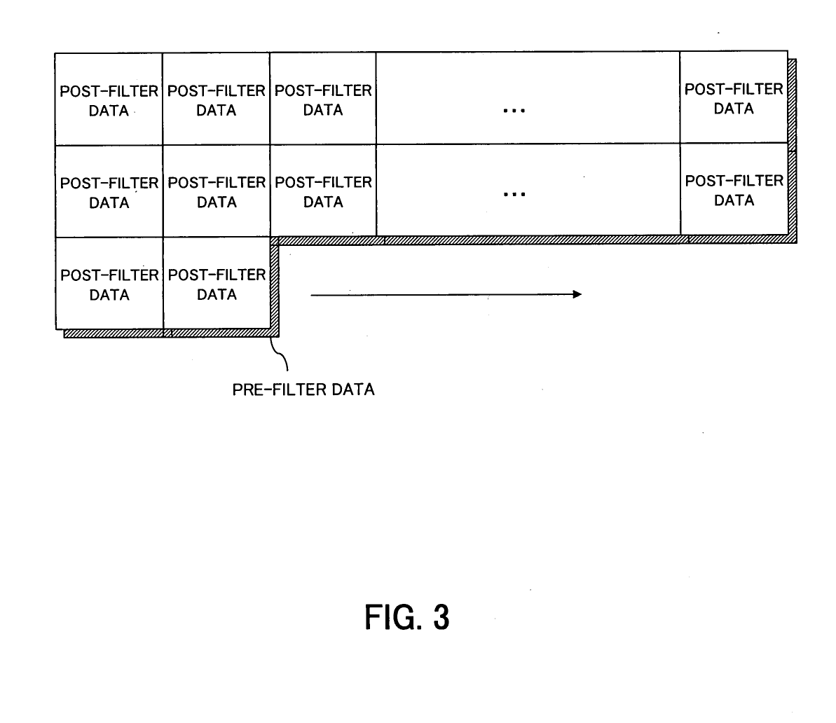

FIGS. 2A and 2B and 3 illustrate processing of the frame memory reading apparatus 30 that can be used to write image data into the frame memory 24.

First, as shown in FIG. 2A, the frame memory 24 stores pre-filter data supplied from the adder 14 in a region offset toward right and lower directions from a target storage region. Then, the frame memory reading apparatus 30 supplies written pre-filter data to the filter 20 that executes the filter processing. The filter 20 produces post-filter data through the filter processing. The frame memory storing apparatus 22 receives the post-filter data from the filter 20 and writes the received post-filter data into the frame memory 24. The frame memory 24 stores the post-filter data to the target storage region, as shown in FIG. 2B.

Namely, the decoding apparatus of the present embodiment overwrites the post-filter data on the pre-filter data in an offset manner. More specifically, when the post-filter data are written into the target storage region of the frame memory 24, a peripheral region of the pre-filter data block can remain without being overwritten by the post-filter data. The peripheral region remaining unchanged corresponds to at least one row and one column (two rows and two columns according to the example shown in FIGS. 2A and 2B) extending along the right and lower sides of the block of the pre-filter data.

When the above-described processing is repeated, the frame memory 24 can store pre-filter data in a peripheral region including a row extending along lower sides of consecutively processed blocks and a column extending along the right side of the last-processed block, as shown in FIG. 3.

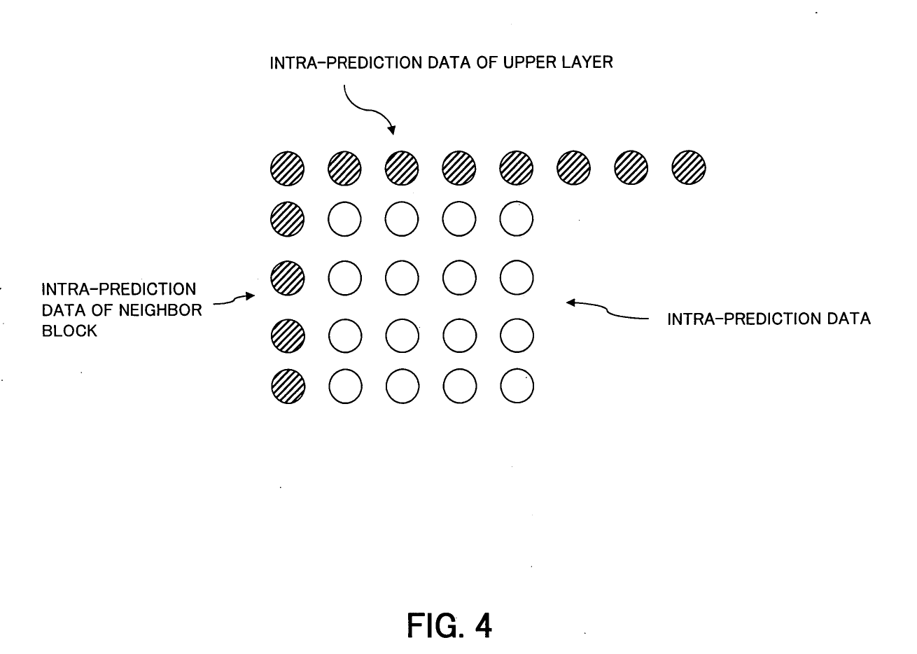

The intra-prediction section 28 executes prediction based on 1-column pre-filter data extending along the left side and 1-row pre-filter data extending along the upper side of the intra-prediction data as shown in FIG. 4. In FIG. 4, each data used for the prediction is indicated by a circle with oblique lines while each data predicted is indicated by a void circle.

A plurality of prediction modes may be employed. In the present embodiment, the intra-prediction section 28 uses 1-row pre-filter data extending along the lower side of the immediate upper-layer block and 1-column pre-filter data extending along the right side of the neighboring block (i.e., last processed block).

As shown in FIG. 3, the frame memory 24 stores 1-column/1-row pre-filter data corresponding to left and upper sides of a target block to be processed. Therefore, the frame memory reading apparatus 30 can read the pre-filter data from the frame memory 24 and supply the read pre-filter data to the intra-prediction section 28. The intra-prediction section 28 can execute intra-prediction based on the received pre-filter data and supply prediction data to the adder 14.

The frame memory 24 stores post-filter data of all processed blocks. Therefore, the frame memory reading apparatus 30 can read necessary data from the frame memory 24 and supply the read post-filter data to the inter-prediction section 32.

As described above, the system according to present embodiment offsets a storage region of pre-filter data relative to a target storage region in the frame memory 24 and overwrites post-filter data on the target storage region. Accordingly, the frame memory 24 can hold both the post-filter data required for the inter-prediction and the pre-filter data required for the intra-prediction. The invention as embodied in the present embodiment can designate necessary pre-filter data and hold the specified pre-filter data only. Accordingly, with the present embodiment, the amount of pre-filter data which must be stored for the prediction can be reduced. Furthermore, the processing required in the present embodiment, which involves changing the writing position, is relatively simple to execute.

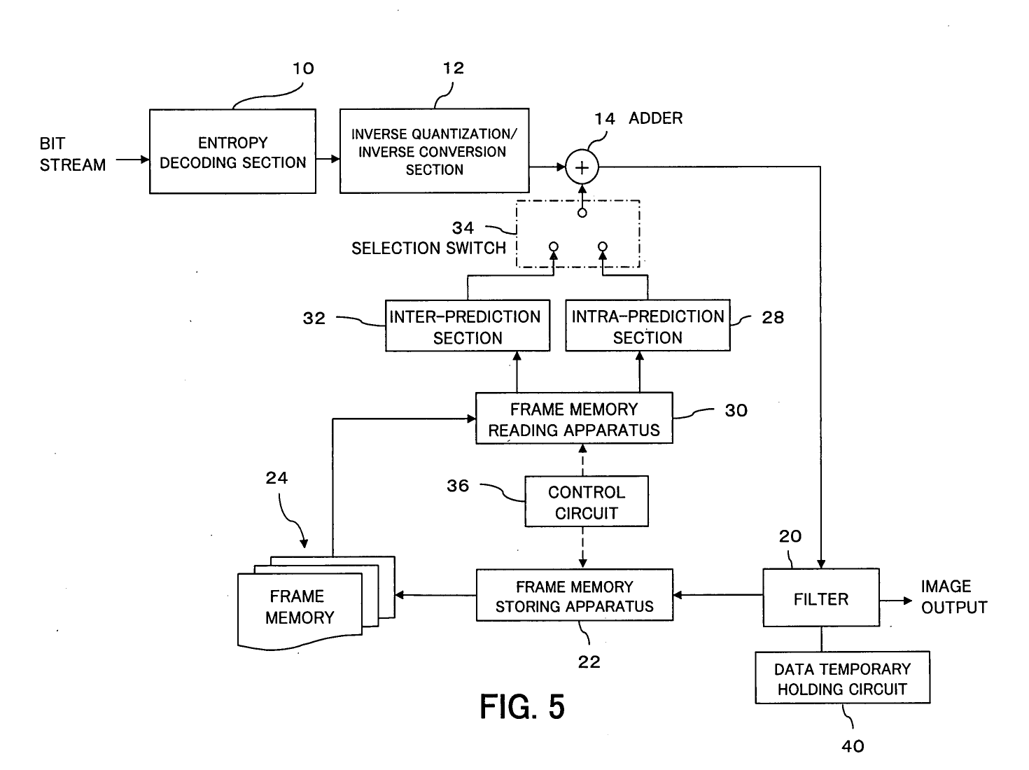

FIG. 5 illustrates a decoding apparatus according to a further embodiment of the present invention. A data temporary holding circuit 40 is connected to the filter 20. The filter 20 directly receives decoded image data from the adder 14. The filter 20 applies filter processing to the received pre-filter data. The data temporary holding circuit 40 designates 1-column/1-row pre-filter data and stores the specified data as data used for the intra-prediction. The filter 20 executes filter processing and produces a block of post-filter data. The frame memory storing apparatus 22 writes into the frame memory 24 both the post-filter data supplied from the filter 20 and the pre-filter data stored in the data temporary holding circuit 40. The processing for writing the data in this case is similar to the aforementioned processing for overwriting the post-filter data described with reference to FIG. 3. Accordingly, the frame memory 24 can store both the post-filter data and the pre-filter data. The intra-prediction section 28 produces an intra-prediction signal based on the pre-filter data. The inter-prediction section 32 produces an inter-prediction signal based on the post-filter data.

In the present embodiment, the data temporary holding circuit 40 can store pre-filter data of a target block to an offset region as illustrated in the above-mentioned FIGS. 2A and 2B and store post-filter data, when obtained through filter processing based on the pre-filter data, to the target storage region. The frame memory storing apparatus 22 can write the obtained 1-block post-filter data and 1-column/1-row pre-filter data into the frame memory 24.

Furthermore, a device other than the filter 20 can be provided to extract pre-filter data required for the intra-prediction. The extracted pre-filter data can be written to a predetermined portion of the frame memory 24. The post-filter data, when obtained, can be written into the frame memory 24. Thus, the frame memory 24 can store the data as shown in FIG. 3.

The intra-prediction performed according to the present invention is not limited to a specific type. The pre-filter data used for the prediction is not limited to 1-column/1-row data. Therefore, if another type of data is used, the method for storing (leaving) necessary pre-filter data in the frame memory 24 can be appropriately selected.

What is claimed is:

1. A decoding apparatus for decoding encoded image data, comprising:
a decoding section configured to input encoded image data and execute inter-prediction using image data of plural frames and intra-prediction using image data in a frame, to obtain decoded image data;
a frame memory configured to store decoded image data;
a filter configured to apply filter processing to the decoded image data stored in the frame memory; and
a frame memory storing unit configured to store pre-filter data used in the intra-prediction and successively overwrite post-filter data on a predetermined region of the pre-filter data that is not used for the intra-prediction, for each block,
wherein the decoding section executes the inter-prediction based on the post-filter data stored in the frame memory and executes intra-prediction based on the pre-filter data stored in the frame memory.

2. The decoding apparatus according to claim 1, wherein the decoding section executes decoding processing for each block, and the frame memory storing unit overwrites the post-filter data on a corresponding block of the pre-filter data so as to leave a portion used for intra-prediction of a next decoded block.

3. The decoding apparatus according to claim 2, wherein the pre-filter data stored in the frame memory is data for one row and one column along the periphery of the block.

4. The decoding apparatus according to claim 1, wherein the frame memory storing unit writes pre-filter data of a target block subjected to the filter processing to a region offset from a target region in the frame memory, and writes post-filter data when obtained through the filter processing based on the written pre-filter data to the target region in the frame memory, so that pre-filter data for the intra-prediction remains in the frame memory.

5. The decoding apparatus according to claim 1, wherein the filter temporarily stores pre-filter data of a target block supplied for the filter processing and applies the filter processing to the temporarily stored pre-filter data, and leaves pre-filter data not subjected to the filter processing and used for intra-prediction, wherein the frame memory storing unit writes both the post-filter data obtained through the filter processing and the pre-filter data used for the intra-prediction into the frame memory.
